(19) United States
(12) Patent Application Publication
(10) Pub. No.: US 2005/0174757 A1
(43) Pub. Date: Aug. 11, 2005

(54) Alteration of existing cobra street light fixture design

(76) Inventor: Samuel Matthew Neely, Los Angeles, CA (US)

Correspondence Address: EDWIN TARVER, 20121 VENTURA BOULEVARD, SUITE 302, WOODLAND HILLS, CA, 91364, US

(21) Appl. No.: 10/321,590

(22) Filed: Aug. 15, 2003

(51) Int. Cl. F21S 8/00

(52) U.S. Cl. 362/145

(57) ABSTRACT

The assembly of this Cleco luminaire material will substantially improve the costs and safety of lighting streets and byways by improving human sight, reducing the power cost as much as fifty percent and reducing the wind load 70%.

### BRIEF SUMMARY OF THIS INVENTION

This invention is for the design of street lighting to be used to illuminate streets and byways. The steel or wood poles for mounting this invention is not included.

This Standard luminaire invention will no longer pollute the sky with excess wasted light. Henceforth it has been universal practice to illuminate the sky with wasted light. Light will travel to infinity unless it is absorbed or redirected. Telescopes across the world can no longer study the stars at night because of this accumulated pollution because of street lighting. As an example, the light pollution from street lights can be seen from aircraft when flying high overhead.

Approximately fifty percent of our precious oil, purchased for electrical energy, is now being wasted in light pollution. England suffered from this same problem and by introducing conservativeness, they partly solved their pollution problem. This can also be partly done in America, through this invention.

Using this invention, a conservative estimate of power savings would be fifty percent. In this day of power cost this would amount to a very substantial dollar savings and then also save wasted power.

One of the purposes of this invention is to increase luminaire lumen output to the target area; decrease the power consumed; produce light beams that are within the human eye sensitive portion of the spectrum and, to use an electrical socket with safety connections.

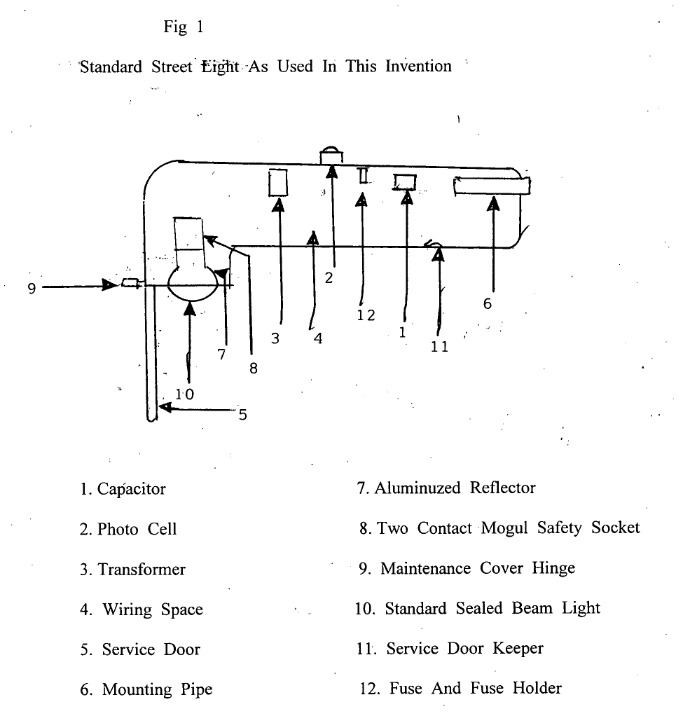

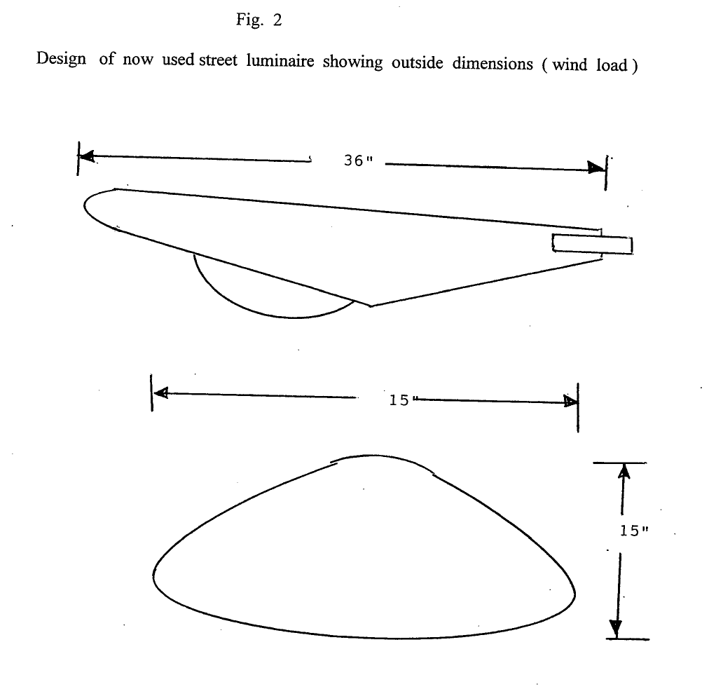

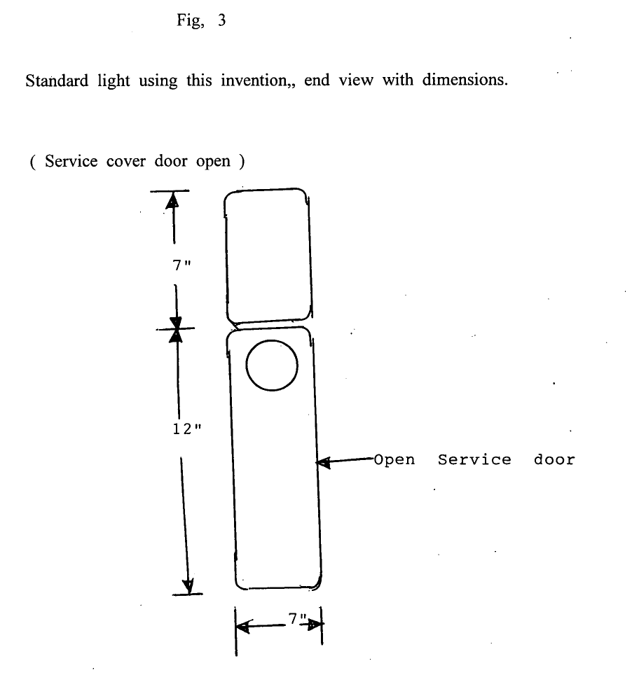

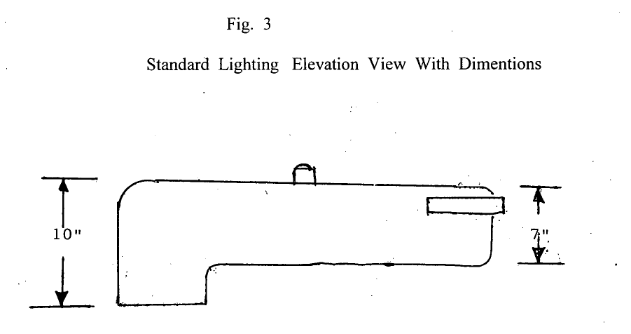

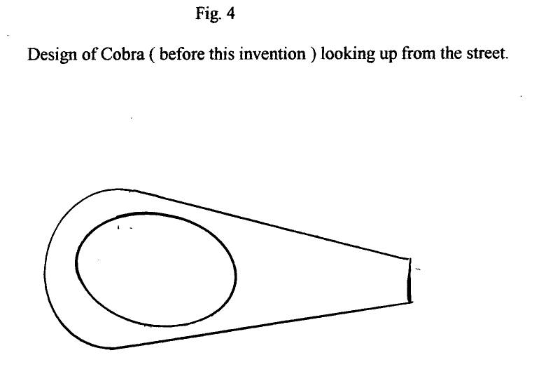

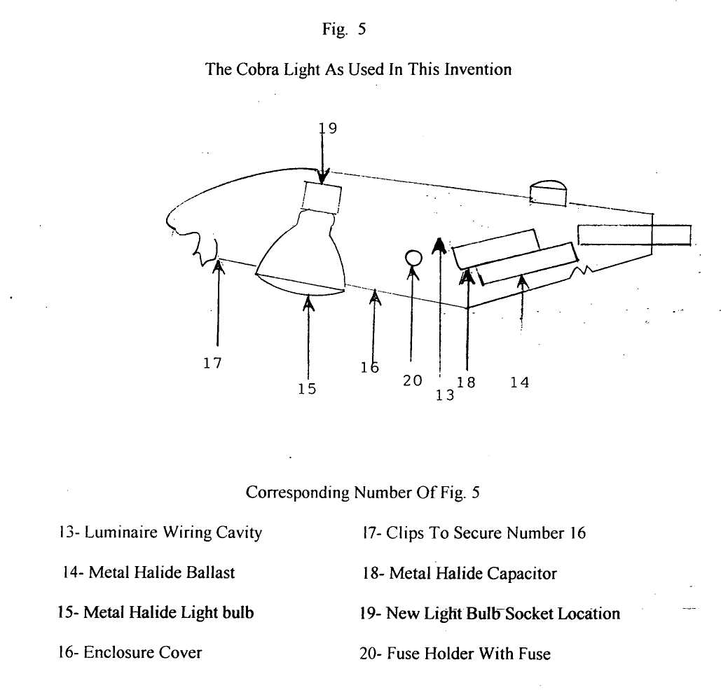

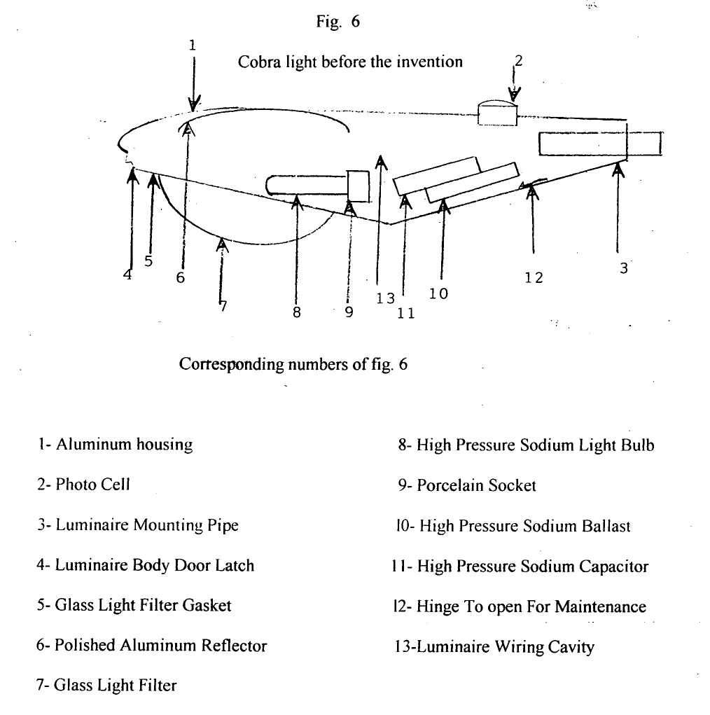

Page 10 (FIG. 1 Location 8) Since, after shutting off the energy to the luminaire, the electrical shocking ability from the capacitor still exists for some time. The safety feature of a two contact socket places the energy on top of the lamp bulb instead of on the side of the light bulb where the workmen could not get shocked. In other words, the screw shell of the lamp bulb is never energized. Further, the wind load over the presently used system page 11 (FIG. 2 ) and page 13 (FIG. 3) is reduced seventy percent when compared to that of page 12 (FIG. 3) which is this invention.

In high winds this is very important. For wind area displacement see page 12 (FIG. 3 ) compared with page 11 (FIG. 2.)

### DETAILED ADVANTAGES OF THIS INVENTION

The light source, metal halide, produces. light beams that are within the human eye sensitive portion of the spectrum. This quality alone will improve safety features simply by the improved see ability of an object under the light for humans. A big advantage is the power savings

Another object of this invention is to fuse, page 10 (FIG. 1, Location 12) the luminaire, to reduce the maintenance cost. Many street luminaire transformers have failed because of this omission in past designs.

This invention is further suited to properly light the streets for human sight because the light beams are properly suited to the human eye sensitive portion of the spectrum. Color rods in the human eye are properly suited for the full color value of metal halide light beams which is a full color spectrum product. Where objects could barely be seen with the existing street lighting methods, this part of the invention would increase the human sight value substantially. Much of that which may not be seen, when using the present design, would now be seen with this new invention, adding safety to our streets and highways.

This invention also allows for sealed beam floodlight lamp bulbs, page 10 (FIG. 1 Location 10) The desirable beam width is stabilized by the filament or arc tube location in the lamp bulb glass envelope with the sealed in reflector which is made in the lamp bulb glass, page 10 (FIG. 1 location 7.) Some installations require wide beams and some narrower beams. The predetermined width of the light beam required for the target may be managed in the manufacture of the light bulb by altering the location of the arc tube.

When converting to this new invention, the user has a choice of doubling the light volume. The light volume doubled would use the same power to be consumed and by getting the. same amount of light would cut the energy requirement in half. The heat resisting glass of the sealed beam lamp bulb page 10 (FIG. 1, Location 10) is adequate for all weather conditions and therefore does not require additional weather protection such as an additional glass filter. The wattage required for this invention could be 50, 75, 100, or 200 watts.

The light beams are not filtered by passing through a filter of any kind thus the target lumens are almost doubled from the light source for the equal load in power.

This invention cannot be used as a sun tanning device and is not being competitive with invention patent application Ser. No. 780980.

### SUMMARY OF THE INVENTION

The invention provides an illumination light source that is within the human eye sensitive portion of the spectrum. Items that are not very seeable add a danger to the safety of highways across the world. Foot candles are the general method of measuring light results and yet much of the light under the present method of lighting our streets (approximately thirty per cent ) is beyond human eye sight. The Standard luminaire, covered by this invention, will produce twice the lumen output when measured in foot candles.

The outside dimensions of the luminaire is reduced by seventy percent which increases the safety in wind load force as well as shipping and assembly cost. The weight of the Standard luminaire is reduced sixty percent over that which is existing.

By using a sealed beam light source:
1. Light beam borders are better controlled.
2The physical weight is reduced substantially because an additional light filter is eliminated. As well as an additional reflector is being
3. The electrical shocking safety of the workmen when changing a light bulb is an added feature of the Standard luminaire by using a two contact socket.
4. The luminaire is fused to reduce maintenance cost. This feature will save transformers as well as other electrical material.

A. Using a sealed beam light bulb as a light source.

B. The light reflecting reflector is within the walls of the light bulb.

C. The electrical safety socket has connections away from the screw base.

D. The wind area is reduced seventy percent over conventional methods.

E. Saving electrical energy over conventional methods.

F. Controlling light beam width altered by the arc tube location

G. To produce light within the human eye portion of the spectrum,

H. The Standard luminaire has perfect light control to eliminate light pollution.

I. All parts of the standard luminaire are readily accessible for easy repair.

J. The Standard Luminaire is fused

K. No additional reflector required to absorb light lumens

L. No light filter required that absorbs light.
